(19) United States
(12) Patent Application Publication
(10) Pub. No.: US 2011/0298689 A1
(43) Pub. Date: Dec. 8, 2011

(54) Device for Sharing Photographs in Social Settings

(75) Inventors: Martijn ten Bh+e,uml o+ee mer, Rotterdam (NL); John Helmes, Cambridge (GB); Kenton Paul Anthony O'Hara, Bristol (GB); Richard Banks, Egham (GB); Abigail Sellen, Cambridge (GB)

(73) Assignee: Microsoft Corporation, Redmond, WA (US)

(21) Appl. No.: 12/793,021

(22) Filed: Jun. 3, 2010

(51) Int. Cl. G09G 5/00

(52) U.S. Cl. 345/1.1

(57) ABSTRACT

A device for sharing photographs in social settings is described. In an example, the device comprises a display surface which extends around a vertical axis of the device such that it provides a cumulative viewing angle of greater than 180°. This enables viewers located all around the device to see images displayed. The display surface may be a continuous display or may be formed from multiple discrete displays. The images displayed comprise sets of related images which may, for example, be accessed from an online image store (such as a social networking site) or other storage device. In an example, sets of images may be displayed in the form of filmstrips, with each filmstrip comprising a set of related images associated with a different user. Where the device includes a user interaction element, detection of a user interaction changes the images that are displayed.

### BACKGROUND

With the popularity and prevalence of digital cameras, either as standalone devices or integrated within other devices such as mobile telephones, users are generating very large numbers of digital images which they may store locally on a hard drive or on removable media, such as a CD, DVD or portable flash memory device. Often these images are stored in an online store, for example using a service such as Microsoft Live™ Photo (http://photos.live.com), Flickr®, or on a social networking site such as Facebook. Many of the images may not be viewed again and those that are viewed are often viewed in an individual setting (e.g. a user sitting in front of a computer or viewing the images on a mobile telephone screen).

Viewing a user's digital photographs in a social setting is difficult and usually involves huddling around a laptop or using a television screen as the display device, with the television being connected to a computer or to a DVD player and with the photographs having been written to a DVD. Another way for a user to display their photographs is using a digital photograph frame; however such devices are typically quite small and store the photographs locally. This means that there is significant additional effort required to change the images stored and consequently the photographs displayed are rarely updated by the user.

The embodiments described below are not limited to implementations which solve any or all of the disadvantages of known display devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A device for sharing photographs in social settings is described. In an example, the device comprises a display surface which extends around a vertical axis of the device such that it provides a cumulative viewing angle of greater than 180°. This enables viewers located all around the device to see images displayed. The display surface may be a continuous display or may be formed from multiple discrete displays. The images displayed comprise sets of related images which may, for example, be accessed from an online image store (such as a social networking site) or other storage device. In an example, sets of images may be displayed in the form of filmstrips, with each filmstrip comprising a set of related images associated with a different user. Where the device includes a user interaction element, detection of a user interaction changes the images that are displayed.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a representation of a group of people in a social setting seated around a dining table and more detailed diagrams of a device for displaying images which is located at the center of the table;

FIGS. 2 and 5 are flow diagrams of example methods of operation of a device for displaying images, such as the device shown in FIG. 1;

FIG. 3 is a block diagram of a device for displaying images, such as the device shown in FIG. 1;

FIG. 4 shows sets of images arranged into a filmstrip format;

FIGS. 6-8 show schematic diagrams of further examples of a device for displaying images; and

FIG. 9 shows a flow diagram of another example method of operation of a device for displaying images.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

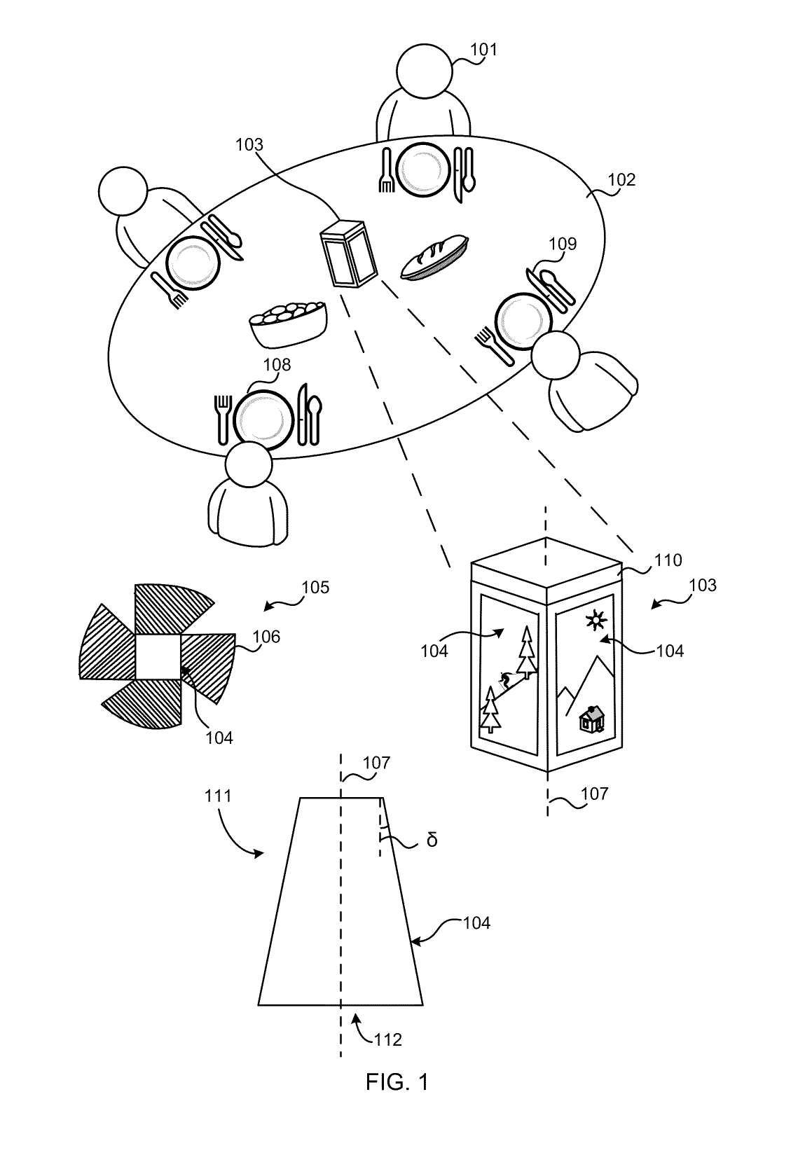

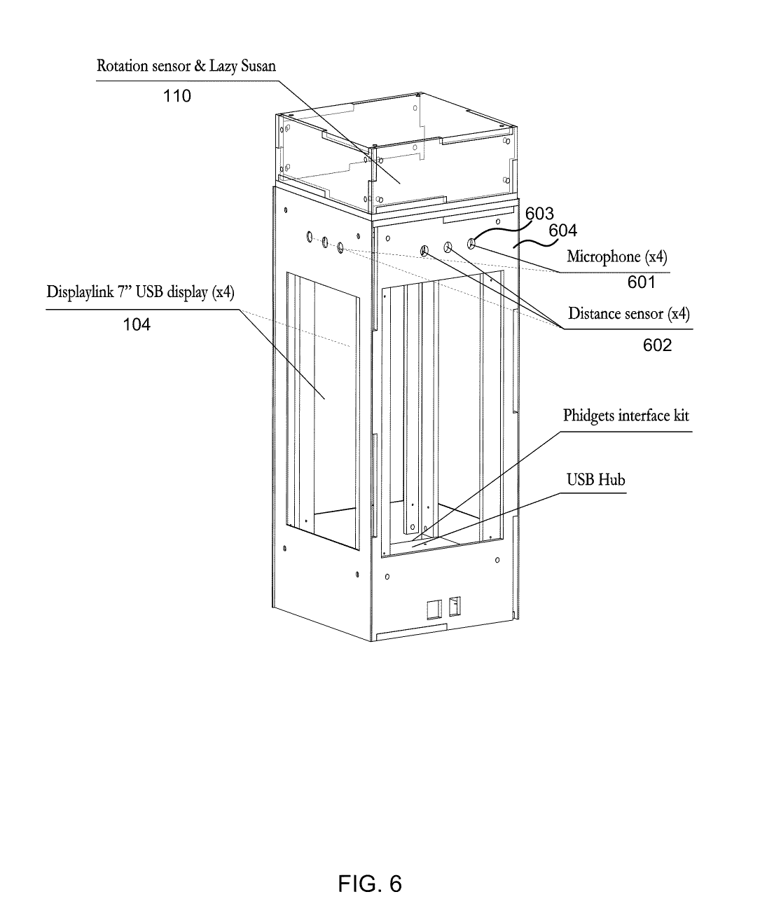

FIG. 1 shows a representation of a group of people 101 in a social setting, in this example, seated around a dining table 102. At the center of the table is a device 103 for displaying images, such as digital photographs, which is also shown in more detail in the lower portion of FIG. 1. The device comprises a display surface which provides a cumulative viewing angle of greater than 180° and therefore allows all the people 101 seated around the table 102 to view the images displayed. In the example shown in FIG. 1, the display surface is formed from four display screens 104, although only two are visible in the perspective view. FIG. 1 also includes a view of the device from above 105 which shows the four screens 104, one on each substantially vertical face of the device, and provides a graphical representation 106 of the viewing angle. It can be seen from this view 105 that the cumulative viewing angle (i.e. the sum of the viewing angles 106 of each of the four displays) of this example device is close to 360°. The arrangement shown in FIG. 1 shows just one example of a display surface which provides a cumulative viewing angle of greater than 180° and further examples are described below and shown in FIGS. 6-8.

As shown in the larger view of the device 103 in FIG. 1, the display screens 104 which form the display surface are arranged around a vertical axis of the device (marked by dotted line 107). The display surface itself may be vertical or may be offset by a small angle, δ, from vertical (as shown in the side view 111 in FIG. 1) to provide an improved viewing angle for the users (e.g. the people 101 around the table). In the example shown, the display screens are titled upwards as the eyes of those viewing the display are above the device, but a different arrangement may be used dependent on the arrangement and mounting of the device (e.g. the display surface may be angled down where it is situated above the viewers, for example where it is mounted on the ceiling). Each of the display screens 104 used to form the display surface is arranged in portrait orientation as this provides an improved form factor: the base area 112 of the device 103 is small and the display surface can be easily viewed over objects (such as crockery 108 and cutlery 109) on the table 102.

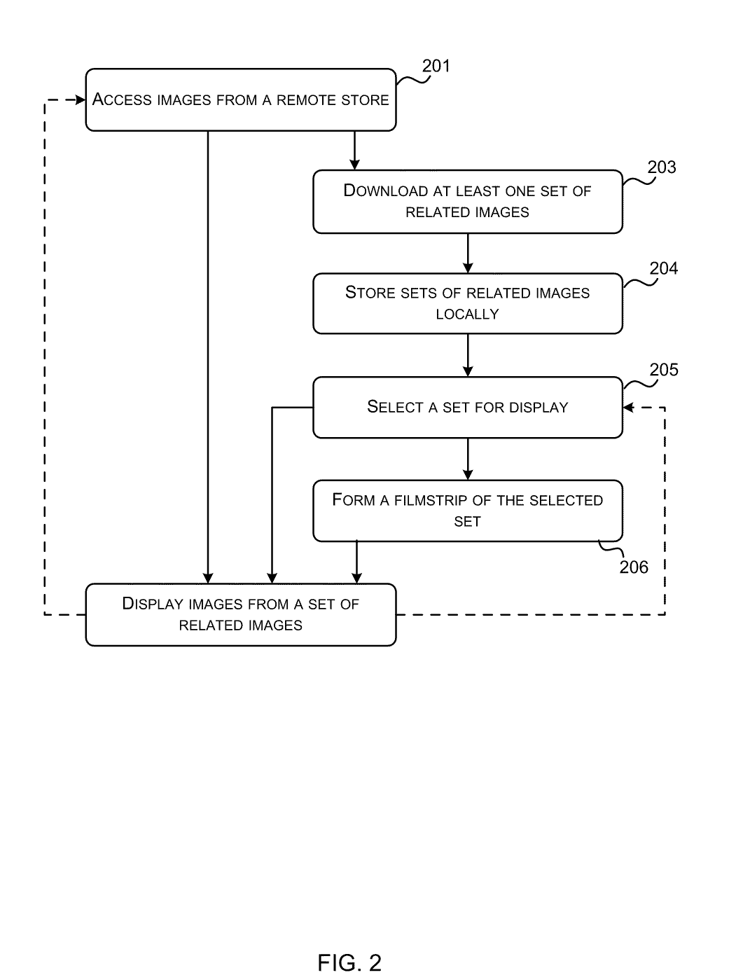

FIG. 2 shows a flow diagram of example methods of operation of a device for displaying images which comprises a display surface which provides a cumulative viewing angle of greater than 180°, such as the device shown in FIG. 1. The images displayed on the device are accessed from a remote image store (block 201) and images from a set of related images are displayed (block 202). In some examples, one or more sets of related images may be downloaded by the device (block 203) and stored locally within the device (block 204) or alternatively, a plurality of images may be downloaded and then sets of related images extracted from the downloaded images. Where there is more than one set of related images, one of the sets is selected for display (block 205) and displayed (in block 202). The set may be selected for display directly (e.g. by selecting set A from sets A-Z) or indirectly (e.g. by selecting user A from users A-Z and then selecting a set associated with user A, where there may be one or more sets associated with a user). The content being displayed may be changed subsequently by selecting a new set from the downloaded sets (as indicated by a dotted arrow back to block 205). Additionally the downloaded content may be periodically refreshed (as indicated by a dotted arrow back to block 201) to provide new sets of related images which may be selected. In some examples, the images being displayed may change as a result of user input and this is described in more detail below.

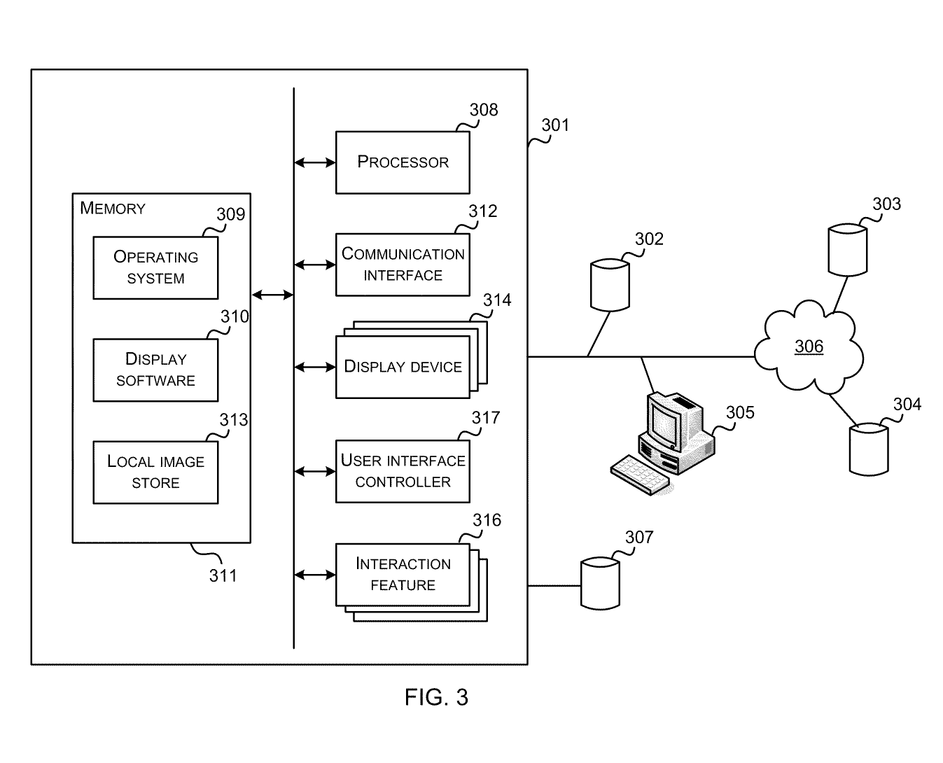

FIG. 3 is a block diagram of a device 301 for displaying images, such as the device shown in FIG. 1 or another device which comprises a display surface which provides a cumulative viewing angle of greater than 180°. FIG. 3 shows the device 301 connected to a number of remote image stores 302-305 and it will be appreciated that the device may access one or more remote image stores (in block 201). The device, 301, which is a computing device, comprises one or more processors 308 which may be microprocessors, controllers or any other suitable type of processors for processing device executable instructions to control the operation of the device in order to display a sequence of images accessed from a remote image store. Platform software comprising an operating system 309 or any other suitable platform software may be provided at the computing device to enable application software, such as display software 310 to be executed on the device. This display software 310 comprises device executable instructions (also referred to as computer program code) which when executed by the device cause the device to access and display a sequence of images. The device further comprises one or more display devices 314 which form the display surface and on which the sequence of images is displayed.

The device executable instructions may be provided using any computer-readable media that is accessible by the device 301. Computer-readable media may include, for example, computer storage media such as memory 311 and communications media. Computer storage media, such as memory 311, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism.

Although the computer storage media (memory 311) is shown within the device 301 it will be appreciated that the storage may be distributed or located remotely and accessed via a network or other communication link (e.g. using communication interface 312). The communication interface 312 is also used to access images from a remote image store (in block 201) and in some examples to download the images (in block 203) so that they can be stored locally (in block 204). Where images are stored locally, they may be stored within a local image store 313. The device may also comprise one or more interaction features 316 (e.g. sensors, buttons, rotatable elements etc.) and a user interface controller 317 and these are described in more detail below.

The remote image store from which the images are accessed may comprise an online image store 303-304 (i.e. an image store accessed via the interne 306), or other remote storage device 302, 305 which is accessible by the device. Examples of online image stores include image hosting services, such as Windows Live™ Photos (http://photos.live.com), Flickr®, Picasa™ and those provided by companies providing digital image services, e.g. Kodak Gallery, Photobox, etc. Further examples of online image stores include social networking sites such as Facebook and MySpace. Examples of other remote image stores which may be accessible to the device include network attached storage 302 and shared drives on computers 305 within a local network to which the device is connected.

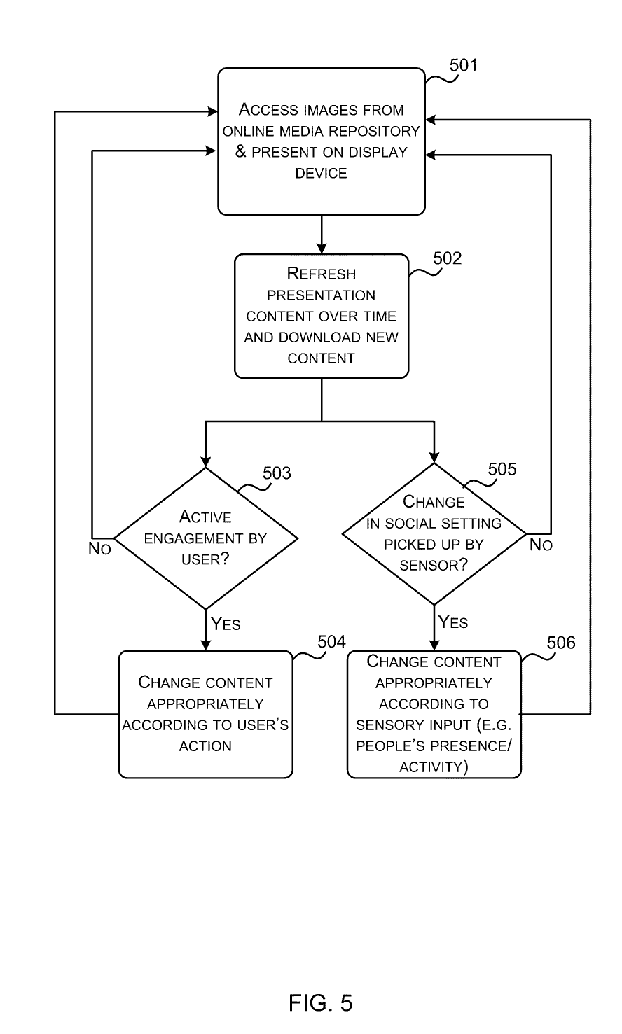

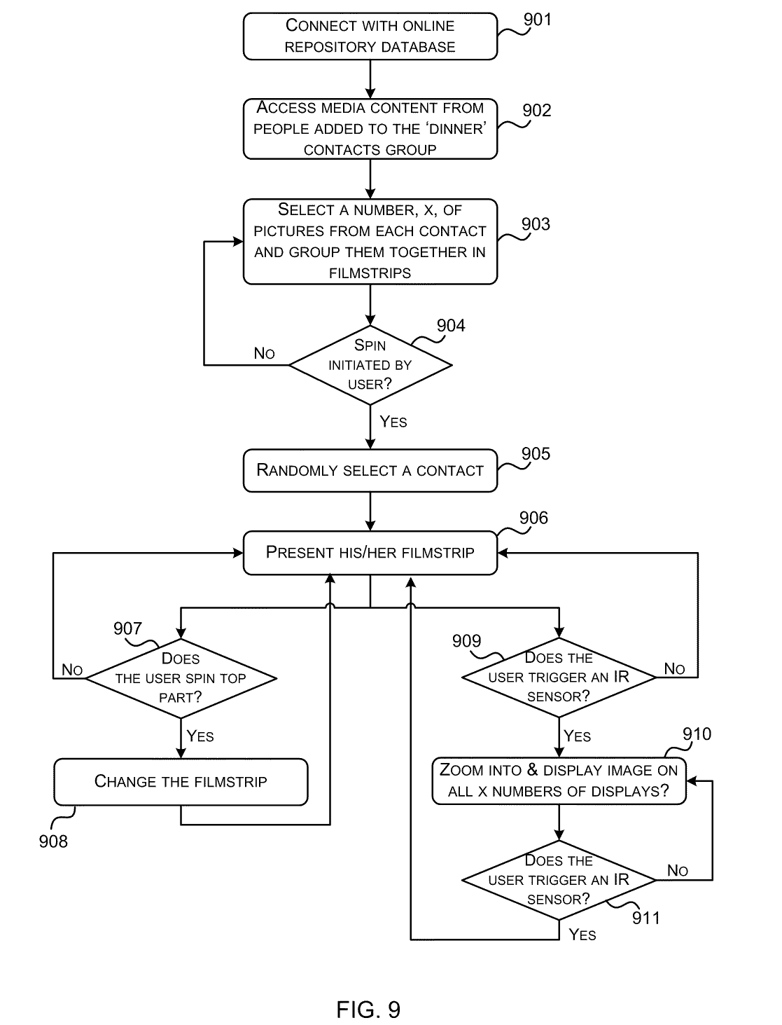

Although the method shown in FIG. 2 (and also those shown in FIGS. 5 and 9 which are described below) refers to a remote image store, in some examples, images are accessed from a local image store 307, which may, for example, comprise a hard drive, memory stick, memory card or other external storage device which may be connected to the device 301. The accessing of images from a local image store 307 may occur instead of, or in addition to, accessing of images from a remote image store 302-305.

The term “image” is used herein in a broad sense to include digital still images such as photographs, video stills, or other digital 2D images, as well as sequences of images such as videos, or other captured or generated sequences of images. The term may also encompass medical images such as CT scans, MRI scans or other digital medical images, digital 3D images or higher dimensional images such as obtained from Z-cameras, voxel volumes, satellite imaging systems, ultra-sound scans, etc, however these are less likely to be displayed in a social setting as described above.

The sets of images displayed by the device (in block 202) comprise related images, where the images may, for example, be related by one or more of the following:
the images are all stored within the same album/folder/set or equivalent (depending on the structure of the particular image store used)
the images were all captured on the same day, and in some examples, by the same image capture device (e.g. by a single digital camera) or by the same user
the images were all captured in the same approximate location (e.g. where a digital camera has location detection capabilities, e.g. using GPS or cellular base station information)
the images are related by their metadata, e.g. they may contain the same (or similar) keywords
the images contain similar or identical elements, e.g. they contain a specific person (determined using face recognition software) or have other visual connections or similarities (e.g. they contain the same landmark)
   It will be appreciated that other criteria may be used to determine which images are related and any suitable criteria may be used.

Each set of images may comprise a relatively small number of images, e.g. 5-10 images or less than 20 images. Where the remote store holds a larger collection of related images, e.g. there may be 100 images within a folder or captured on a particular day, a set of images may be selected from the collection according to one or more factors, such as the capture time, the image title, the capture device etc, or may be selected substantially at random from the collection. The number of factors, or the tightness of the factors used may depend on the size of the collection of related images, e.g. where the collection is bigger, more factors or tighter factors may be used to select a set of related images than where the collection is smaller.

In many embodiments, the images from a set of related images are displayed sequentially (in block 202); however in some examples, more than one image may be displayed at the same time on a single display screen 104, e.g. in the form of thumbnails of each image in the set. Through use of related images, the display device is able to tell a story or to encourage the people around it to tell a story. In an example, the set of related images may be from a folder for a particular event (e.g. a birthday party) or a holiday, which may trigger discussion of these subjects.

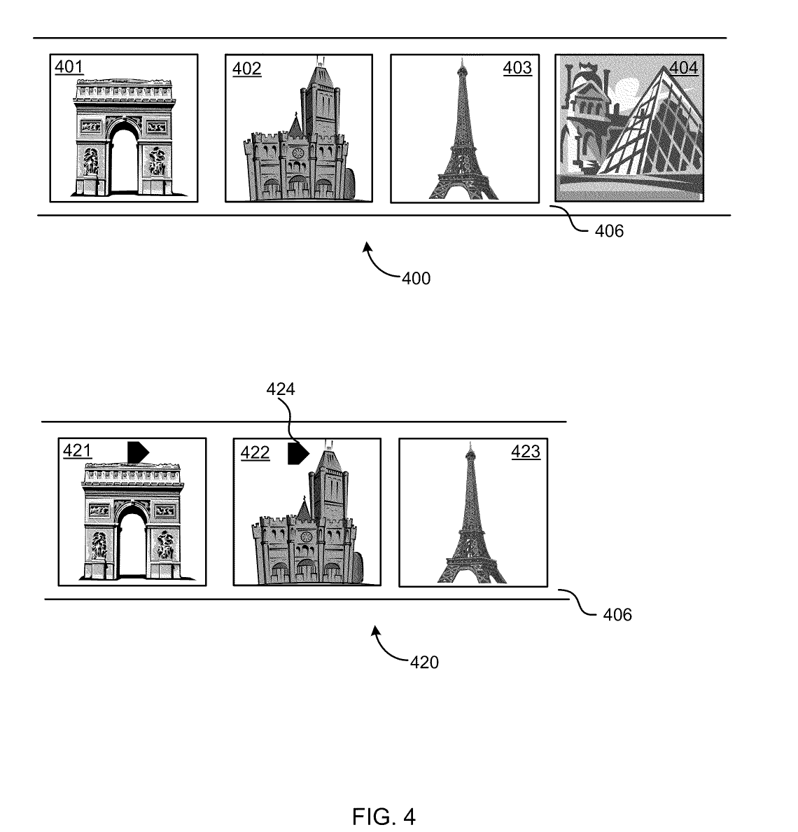

In an example, a set of related images may be displayed (in block 202) in the form of a filmstrip 400, as shown in the schematic diagram of FIG. 4. In the example shown the filmstrip 400 comprises four related images 401-404. The filmstrip may be displayed moving around the display surface (e.g. substantially horizontally around the vertical axis). This has the effect that different images are seen when viewing from (significantly) different angles, e.g. people sitting next to each other (who view the same or adjacent screens) may see the same image but people sitting diagonally opposite each other will see different images. In the example of FIG. 1, the filmstrip may be displayed moving from one display screen 104 to the adjacent screen 104 such that it appears to be rotating around the display surface of the device 103. Where the filmstrip form is used, the selected set is formed into a filmstrip (in block 206 of FIG. 2) prior to display (in block 202).

Where more than one set of images is downloaded (in block 203), each set may be associated with a different user. For example, a first set may comprise images from a Facebook folder from the first user's account, a second set may comprise images from a Facebook folder of the second user etc. In such an instance, the border area 406 around the images 401-404 in the filmstrip may be color coded to identify the particular user who is associated with the images being displayed, e.g. filmstrips containing content belonging to user 1 may be blue and filmstrips containing content belonging to user 2 may be red etc. In other examples, different identification means may be used, e.g. displaying the user's name or a small image of the user (e.g. their profile image from a social networking site) or one of the images from the selected set.

The device for displaying images may further comprise one or more interaction features which enable users (e.g. the people 101 seated around the table 102 in FIG. 1) to interact with the device and as a result influence the images that are being displayed and/or how the images are displayed, as shown in FIG. 5. Examples of interaction features 316 (as shown in FIG. 3) include a rotatable element linked to a rotation sensor, a distance sensor (e.g. an infra-red sensor), a microphone, other types of sensors, buttons and touch sensitive displays. An interaction feature 316 may operate in combination with a user interface controller 317 in order to change the content which is displayed.

FIG. 5 is a flow diagram of an example method of operation of a device for displaying images which includes one or more interaction features. As described above, the device accesses images from a remote store and displays images from a set of related images on the display surface (block 501) and even without user interaction, the displayed content may be periodically changed and new content downloaded (block 502).

As described above in relation to FIG. 2, the images may be accessed and displayed directly or may be downloaded to a local image store 313. Where images are downloaded to a local image store 303, the images may only be stored temporarily (e.g. for a period which is no longer than 24 hours) and then the images may be deleted automatically.

If a user interaction is detected (in block 503, e.g. by the user interface controller 317), the content displayed is changed according to the detected interaction (block 504) and examples of the interactions and how they may affect the displayed content is described in more detail below.

A rotatable element 110, which may, for example, be mounted on the top face of the device (as shown in FIG. 1) provides an interaction feature which can be used from any angle around the device. This means that in the situation shown in FIG. 1, any of the people 101 seated around the table may use the rotatable element 110. The rotatable element is linked to a rotation sensor and the output of the rotation sensor is used to influence what images are displayed on the device. It will be appreciated that FIG. 1 shows just one possible arrangement of a rotatable element which is accessible from all angles around the device and in another example, the device itself may rotate on a base portion. In a further example, a rotatable element may be provided on a substantially vertical face of the device and there may be one on each substantially vertical face (e.g. four in the square configuration of screens shown in FIG. 1).

In an example, if a user spins the rotatable element 110, the device may select a new set of related images for display substantially at random from the available sets (e.g. from those sets stored locally in block 204 of FIG. 2). In an example, there may be four users, Alice, Bob, Caroline and David seated around a table on which the device is located. The device may have downloaded and stored (in blocks 203-204) a set of images associated with Alice, such as images selected from one of Alice's folders on Facebook. Corresponding sets of images may also be downloaded for each of Bob, Caroline and David from their Facebook accounts. When someone spins the rotatable element, one of the four sets may be selected at random from the downloaded sets and the images selected from one of the Facebook folders displayed.

In some examples there may be more than one set per user and the selection of a set may comprise the selection of a user (e.g. user A from users A-F) and then selection of one of their sets. Alternatively, a set may be selected from all available sets (e.g. from sets A-Z). Other selection criteria in response to the spin feature may be used, e.g. selection of a set of images at random from all downloaded sets, selection of a particular remote image store at random, or any combination thereof etc.

In another example, if a user turns the rotatable element 110 slowly this may enable the user to select a particular set of images or a particular user's content for display. For example, as the user turns the rotatable element slowly, the names of the different sets or users which are stored locally may be displayed so that the user operating the rotatable element can stop when the name they want is displayed. Using the example from the previous paragraph, if sets of images from each of Alice, Bob, Caroline and David's Facebook accounts are downloaded, the names Alice, Bob, Caroline and David may be displayed in turn as a user rotates the rotatable element. In order to display David's content, the user may rotate the element until the name ‘David’ is displayed on the display surface. In other examples, alternative means of identifying a person may be used instead of text, such as an image of that person. Where this interaction selects a set rather than a user, the folder name or a representative image (e.g. the first image) and/or a thumbnail of all the images may be displayed as the rotatable element is turned.

It will be appreciated that a device which incorporates a rotatable element 110 may provide one or more different interaction modes using the element. For example, a device may provide both the “spin” feature for random selection and the slow rotation feature for selection of a specific set/user.

Distance sensors may be located around the top of the device, e.g. above each display screen, to provide an interaction feature. An example of a suitable sensor is a reflective infra-red distance sensor which generates an analog voltage with a value which is proportional to the distance of the detected object. Such sensors may also be referred to as analog output type distance measuring sensors and may use technologies other than infra-red. By locating the distance sensors towards the top of the device they are less likely to be obscured by other items on the table (or other surface) on which the device is placed and by locating sensors on all (or most) of the substantially vertical sizes, the device enables interaction from different angles (e.g. from all around the device) and, in the example of FIG. 1, all the people seated around the table can interact by means of the distance sensors.

In an example, if the distance sensor detects an object coming close to the sensor, e.g. as a result of a user putting their hand out towards the device, the device may pause a filmstrip being displayed and display the image that was displayed on the face corresponding to the detected gesture, on all faces of the device (i.e. such that multiple copies of the same image are displayed). This enables a user who sees an image that they would like to talk about or ask questions about, and which may not be being viewed by other people who are present but viewing from a different angle, to ‘push’ that image to everyone viewing the device. That image may then be displayed for a defined period of time before the filmstrip resumes or alternatively the image may be displayed until another gesture is detected (as shown in the example of FIG. 9), upon which the device may resume display of a filmstrip (which may be the same one or a different one). In another example, detection of an object (e.g. a hand) coming close to the sensor may result in the device zooming in on the image currently being displayed on the particular face of the device. Detection of an object moving away, may cause the image to be zoomed out (e.g. back to the original level of zoom prior to the original detection). Such interaction provides a simple, non-contact way for a user to interact with the media being displayed.

Another sensor which may be incorporated within the device is a microphone and this sensor may be used to detect a specific user interaction, (e.g. a voice command, as in block 503 of FIG. 5) or to detect a change in the social setting (in block 505), e.g. through detection of the volume level, such as the average volume, of the surroundings. In an example of a voice command, a user may shout ‘stop’ or ‘pause’ to cause an image to be pushed to everyone viewing the device (in a similar manner to the hand gestures described above) or give another command to cause a new set to be selected for viewing substantially at random (in a similar manner to using the rotatable element described above). Where the microphone is used to detect a change in the social setting (in block 505), e.g. through volume detection, the detected volume may influence the way the images are displayed and/or what is displayed (in block 506). In an example, where a low volume or silence is detected, the device may select a new set of related images for display or may increase the speed with which the images are displayed (e.g. the filmstrip may move faster around the display surface of the device or the sequential display may have an increased refresh rate). In another example, where the volume level increases, this may be the result of a particularly interesting or amusing image being displayed and as a result detection of an increase in volume level may result in the device decreasing the speed with which the images are displayed or where a volume exceeds a threshold may result in pausing the display.

Touch sensitive displays may be used to enable user interaction with the device as well as for displaying the images (e.g. a touch sensitive display acts as both a display device 314 and an interaction feature 316 in FIG. 3). In an example, touching a display may trigger the image being displayed on that display to be pushed to all displays (as described above in relation to the distance sensors). However, use of non-contact sensing, such as a distance sensor, may be more appropriate for such interaction given the social setting (e.g. at a meal a user may not have clean fingers or when seated around a table they may not be able to reach far enough to touch the device easily) and the use of touch sensitive displays may alternatively be used for more detailed interaction with the device, such as changing settings, selecting the remote image stores to use, selecting the people from which content should be presented etc.

As described above, a microphone may provide an interaction feature to allow a user to change the operation of the device. A microphone may in addition (or instead) be used to capture the reaction of the users, e.g. to display of a particular image or set of images or to otherwise capture the social setting. In another example, the device may comprise one or more cameras (e.g. one camera above each display screen) to record a reaction to display of images or more generally to record the social gathering. The recorded data, whether audio and/or visual, may be stored locally on the device and/or uploaded to a remote image store.

The above description of interaction features provides examples of interaction features and the corresponding functionality that they provide in operating the device which displays images. It will be appreciated that alternative interaction features may be provided in order to achieve the same functionality. For example, instead of a rotatable element, a button (e.g. on the top face of the device) may initiate the ‘spin’ feature which selects a set of images at random to be displayed and/or multiple button presses may be used to step through different users/sets (like the slow rotate function described above). Other types of sensors may also be used. It will also be appreciated that a display device such as those described herein may comprise none, one or more interaction features.

The interaction features described above provide lightweight interaction cues, compared to the types of interaction which are typically achieved with a computing device using a mouse and/or keyboard. Such lightweight cues are more appropriate for the social setting in which the device described herein is designed to be used. It will be appreciated that in addition to the lightweight cues, more intense interactions may be required to configure the device and as such the device may have the facility for connection of a mouse/keyboard or equivalent functionality through use of touch sensitive screens (e.g. using an on-screen keyboard).

FIG. 6 shows a schematic diagram of a further example of a device for displaying images which provides a cumulative viewing angle of greater than 180° and which also includes multiple interaction features. This example includes a rotatable element 110, which may also be referred to as a ‘spinner’, connected to a rotation sensor (not visible in FIG. 6), a plurality of displays 104 (one on each of the substantially vertical sides), and microphones 601 and distance sensors 602 mounted behind holes 603 in the casing 604.

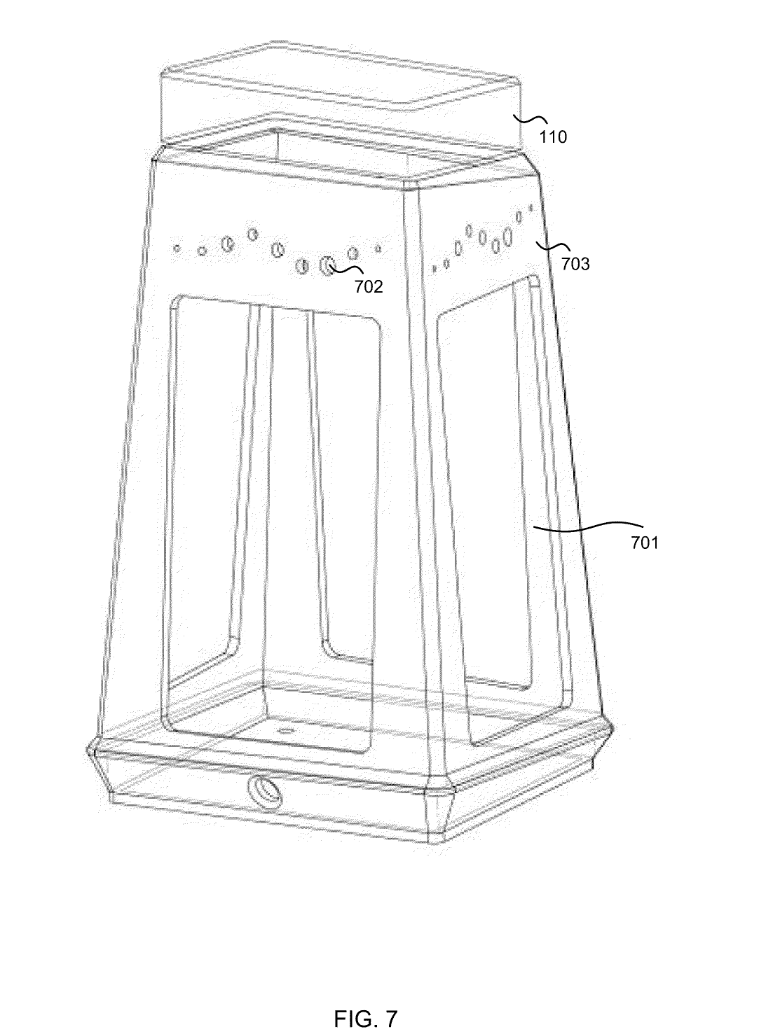

Although the devices shown in FIGS. 1 and 6 have a square horizontal cross-section, the display screens which form the display surface may alternatively be arranged differently and FIG. 7 shows a schematic diagram of a further example of a device for displaying images which comprises four display screens (which would be located in recesses 701) arranged in the shape of a rhombus. This example device provides a cumulative viewing angle of greater than 180° and also includes multiple interaction features: a rotatable element 110 connected to a rotation sensor (not visible in FIG. 7) and microphones and/or distance sensors mounted behind holes 702 in the casing 703.

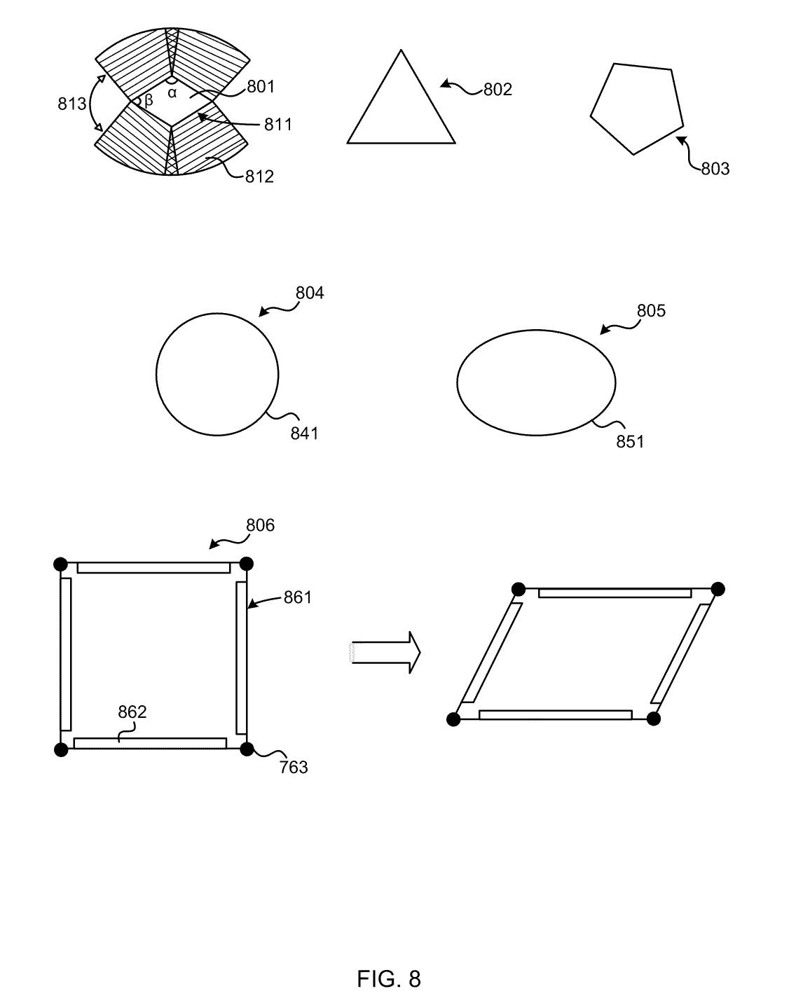

FIG. 8 shows further examples of a device for displaying images which comprises a display surface which provides a cumulative viewing angle of greater than 180° and in each case, the examples are shown in plan view from above. In the first example, 801, the device comprises four display screens 811 arranged in the shape of a rhombus, as in the example shown in FIG. 7. The viewing angles of each screen are shown as shaded regions 812 and in this example, the viewing angles from pairs of screens separated by an obtuse angle, α, have overlapping viewing angles (as indicated by the double-shaded regions). As with the first example, the cumulative viewing angle is close to 360°, but there are two ‘blind spots’ (one of which is indicated by arrow 813) around the points where the screens are separated by an acute angle, β.

Further examples of a device for displaying images which comprises a display surface which provides a cumulative viewing angle of greater than 180° may include devices with different numbers of display screens. A typical LCD screen provides a viewing angle (in the horizontal plane) of 140-165° and therefore, where the display surface is comprised of flat LCD screens, the device comprises at least two screens. The second and third examples in FIG. 8, 802, 803 show devices with different numbers of faces and consequently comprising different numbers of display screens.

The next two examples in FIG. 8, 804, 805 each comprise a continuous display surface 841, 851 onto which the images are projected from inside the device. In an example, a single internal projector providing 360° circular projection may be used and in other examples, multiple projectors may be used to provide the 360° circular projection. In one example 804, the cross-section is substantially circular and in the other example 805, the cross-section is substantially elliptical. As with the other examples described herein, the display surface may be vertical (e.g. a vertical sided cylinder) or may be angled slightly to vertical (e.g. a tapering cone shape, in a corresponding manner to that shown in side view 111 in FIG. 1) to provide a better viewing angle for users.

In further examples, the device may formed such that its shape can be changed, e.g. between a square cross-section and a rhomboid cross-section, as in example 806 shown in FIG. 8. In this example the device has four sides 861 and a display screen 862 is mounted on each side. The sides are connected together using movable joints 863, which may, for example, comprise hinged joints to enable the angles between sides to be altered. With such a device, users may change the relative positions of the display screens according to the particular setting in which the device is to be used. For example, if the device is placed on a circular table, a square cross-section may be appropriate, however if the table is rectangular, a rhomboid cross-section may provide viewing angles more suited to the positions of users around the device. Although it is the four-sided variant which is shown in FIG. 8 with moveable joints between sides, it will be appreciated that this is by way of example only and in further examples, devices with different numbers of sides (e.g. example 803) may have some/all sides connected with moveable joints.

In a further variation, not shown in FIG. 8, curved display screens may be used. Through use of multiple such curved display screens, a substantially continuous display surface having an elliptical or circular cross-section may be formed (e.g. similar to examples 804, 805). In yet a further variation, flexible displays may be used which provide another way to enable a user to change the arrangement of the display surface to suit a particular setting.

FIG. 9 shows a flow diagram of another example method of operation of a device for displaying images as described above and shown in FIGS. 1 and 6-8. The device connects to a remote image store, which may be an online repository database (block 901) and accesses images associated with each person in a particular contacts group (block 902). It will be appreciated that the device may connect (in block 901) to one or more remote image stores and that the images may, in some examples, be downloaded (in block 902) to a local image store within the device. In the example of FIG. 9, the contacts group is a ‘dinner’ contacts group which may have previously been populated by a user. In an example, the contacts group may be the attendees to a particular event set up using a calendar facility, such as provided in a social networking site or email service or the contacts group may be a dedicated group which is associated with the particular device. In another example, the contacts group may be specified directly on the device, e.g. through use of a touchscreen as a user interface device. In an example, the device may access, and in some cases download, (in block 902) images corresponding to a recently updated folder in a social networking site for each of the people in the group. The device then selects a number of related pictures for each contact and groups them to form a filmstrip for each contact (block 903). As described above, the different filmstrips may be color coded to identify different contacts.

When a user spins a rotatable element on the device, or otherwise interacts with the device to initiate a ‘spin’ operation' (e.g. by pressing a button on the top of the device), as detected in block 904, the device randomly selects a contact (block 905) and presents that contact's filmstrip. Further user interaction (detected in blocks 907 and 909) results in a change to the displayed content (in blocks 908 and 910). If another spin operation is initiated (‘Yes’ in block 907) the filmstrip being displayed is changed (block 908), e.g. another contact may be selected at random (as in block 905) and that contact's filmstrip displayed (as in block 906). If a user triggers an infra-red sensor (or other distance sensor), as detected in block 909, the device zooms into the image currently being displayed adjacent to the sensor and displays this enlarged image on all sides of the display surface (block 910 e.g. on each of the display screens 104 in the example of FIG. 1). On detection of a further trigger of the infra-red sensor (in block 911), the device resumes the display of the selected contact's filmstrip (in block 906).

It will be appreciated that there are many possible variations to this method of operation. For example, in the method shown in FIG. 9, a contact is selected and then their filmstrip is displayed. In a variation of this, a filmstrip may be selected at random from those created (in block 903) and then displayed. In a second example, the method of FIG. 9 comprises downloading images for each of the contacts and then selecting images from which to form the filmstrip. In a variation of this, only a particular number of images may be downloaded (in block 902) and all those images used to form the filmstrip. This variation moves the image selection process earlier in the method (from block 903 to block 902) and reduces the amount of data which is downloaded.

The examples above describe the display of sets of images which may belong to different users and as a result there may be privacy considerations. Images which are accessed from social networking sites may use the site's ‘friends’ security policy to control whether it is possible to access particular images. For example, if the ‘owner’ of the display device is a friend of the person who uploaded the images, the display device (using the owner's log-in details) may be allowed to access and download images. Other online image stores, such as Flickr®, have similar privacy settings which may be used. In other examples, where a user accepts an invitation to an event (e.g. using a calendar functionality), they may provide authorization (or be deemed to have provided such authorization) for the device to access some images for display. In further examples, each user may be required to log-in to the display device (or otherwise set access privileges) in order that their images can be downloaded and displayed on the device.

As described above, the term ‘image’ includes both still images and videos. Where videos are displayed on the device, the same video may be displayed on all sides of the display surface or a still image from the video may be included in a filmstrip, as shown in the second filmstrip example in FIG. 4. In the second filmstrip 420, which comprises three still images 421-423, two of the still images 421, 422 are taken from different videos and the fact that the still image represents a video is indicated by an icon 424. Detection of a user gesture (e.g. using a distance sensor or voice prompt) may, for example, be used to trigger the playing of the video corresponding to the still image. In another example, the videos may play within the filmstrip as it moves around the display surface. In either case, the user may be able to interact with the device such that, if a user views the filmstrip 420 which comprises one or more videos (whether they are displayed as a still image 421 or playing), they may gesture towards the device, in response to seeing a particular video (or still image from a video) displayed on the face of the device which is towards them, thereby triggering a distance sensor and causing the corresponding video to play on all sides of the device. Where the device displays videos, there may be an accompanying audio track and the display device may comprise one or more speakers.

The device described above is arranged principally to display images; however in some examples, the device may also display text. This text may, for example, be the names of sets or users (as described above in relation to use of the rotatable element) or comments associated with particular images. For example, where images are sourced from a social networking site, such as Facebook, other users may have commented on an image and these comments (or posts) may be displayed with the image. In an example, the text may be embedded within or displayed around the edge of the image (e.g. above or below the image in the margin 406 of the filmstrip) or in front of the image or in any other manner. In another example, the text may form a separate filmstrip which is displayed flowing around the display surface of the device substantially at the same time as the filmstrip of images.

Text may also be displayed to enable a user to configure the device (e.g. by identifying a group of people or particular remote image stores) and in addition to the interface features described above, standard user interface devices may be useable with the device (e.g. mouse, keyboard). In addition, or instead, a user may be able to configure the device through a web interface accessed from another computing device (e.g. in a corresponding manner to configuring a home router) or the configuration may be integrated within functions of a social networking site (e.g. as described above with reference to FIG. 9).

Although the examples shown in the FIGS. 1 and 6-8 and described above show arrangements of display screens of equal sizes, in some embodiments which comprise multiple display screens, the screens may not all be identical. Where one or more of the screens are of a different size to others of the screens, the screens may form a device having a base which has another shape (e.g. a different quadrilateral such as a rectangle or parallelogram).

Although the present examples are described and illustrated herein as being implemented in as a standalone device with a particular form factor (e.g. with a base which has a smaller side/diameter than the height of the device), the system described is provided as an example and not a limitation. As those skilled in the art will appreciate, the present examples are suitable for application in a variety of different configurations. Furthermore, although the device is designed for use in social settings, such as at meal times, at parties, in a communal space, it may also be used in other settings (e.g. for business purposes, such as advertising or marketing or in a meeting environment).

The devices described herein provide a viewing angle which is larger than 180° and in many examples is close to 360°. This provides a device which is suited to multi-user viewing, unlike known digital picture frames which, in addition to being small, have relatively poor viewing angles. Many of the examples described herein include interaction features which allow a user to directly manipulate or interact with the content being displayed (e.g. direct selection of content or zooming/emphasizing content) and such capabilities are not available in existing digital picture frames.

The term ‘computer’ or ‘computing device’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A device for displaying images to a plurality of viewers, the device comprising:
a display surface providing a cumulative viewing angle of greater than 180° around a vertical axis of the device;
a processor; and
memory arranged to store executable instructions, which when executed cause the processor to:
access a plurality of images from a remote image store; and
display a set of related images on the display surface.

2. A device according to claim 1, further comprising an interaction feature and wherein the memory is further arranged to store executable instructions, which when executed cause the processor to change the images displayed in response to detection of user interaction with the interaction feature.

3. A device according to claim 2, wherein the interaction feature comprises a rotatable element and a rotation sensor arranged to detect rotation of the rotatable element and wherein changing the images displayed in response to detection of user interaction with the interaction feature comprises:
selecting a different set of related images for display in response to detection of rotation of the rotatable element.

4. A device according to claim 3, wherein selecting a different set of related images for display comprises selecting a set of related images at random from a plurality of sets of related images.

5. A device according to claim 3, wherein the set of related images is associated with a first user and the different set of related images is associated with a different user.

6. A device according to claim 2, wherein the interaction feature comprises a plurality of distance sensors arranged around the vertical axis and wherein changing the images displayed in response to detection of user interaction with the interaction feature comprises:
displaying the same image on each side of the display surface in response to detection of a user interaction with the distance sensor.

7. A device according to claim 1, wherein the memory is further arranged to store executable instructions, which when executed cause the processor to:
select a set of related images for display; and
form a filmstrip comprising the images from the selected set, and wherein displaying the set of related images on the display surface comprises displaying the filmstrip moving substantially horizontally around the display surface.

8. A device according to claim 1, wherein the display surface comprises a plurality of display screens arranged around the vertical axis of the device.

9. A device according to claim 8, wherein each display screen is in portrait orientation.

10. A device according to claim 1, wherein the display surface comprises a curved display surface and wherein the device further comprises a projector arranged to project images onto the curved display surface.

11. A device according to claim 1, wherein the remote image store comprises an online image store.

12. A device according to claim 11, wherein the online image store comprises a social networking service.

13. A device according to claim 11, further comprising a local image store and wherein the memory is further arranged to store executable instructions, which when executed cause the processor to:
download images associated with each user in a contact group;
select a plurality of related images associated with each user to form a set of related images for each user in the contact group;
select for display, one of the sets of related images.

14. A device for displaying images to a plurality of viewers, the device comprising:
a display surface extending substantially around a vertical axis of the device;
a processor; and
a memory arranged to store executable instructions which, when executed, cause the processor to:
access a plurality of images from an image store;
select a set of related images for display;
form a filmstrip comprising a linear sequence of the images from the set of related images; and
display the filmstrip moving substantially horizontally around the display surface.

15. A device according to claim 14, further comprising a rotatable element on a top face of the device coupled to a rotation sensor, and wherein the memory is further arranged to store executable instructions which, when executed, cause the processor, in response to detection of rotation by the rotation sensor to:
select a second set of related images for display;
form a second filmstrip from the second set of related images; and
display the second filmstrip moving substantially horizontally around the display surface.

16. A device according to claim 15, further comprising a local image store, wherein the memory is further arranged to store executable instructions which, when executed, cause the processor to download a plurality of sets of images from the remote image store to the local image store, and wherein the second set of images is selected at random from the plurality of sets of images in the local image store.

17. A device according to claim 14, further comprising a distance sensor and wherein the memory is further arranged to store executable instructions which, when executed, cause the processor to display at least two copies of a single image from a filmstrip on the display surface in response to detection of a user interaction by the distance sensor concurrently with display of the filmstrip.

18. A device according to claim 14, wherein the display surface is formed from a plurality of planar display devices.

19. A device according to claim 14, wherein the media store comprises a remote media store.

20. A device for displaying images comprising:
a display surface extending substantially around a vertical axis of the device;
a rotatable element on a top face of the device;
a processor; and
a memory arranged to store device executable instructions which, when executed, cause the processor to:
access a plurality of sets of related images from an online image store;
select and display a first set of related images on the plurality of display devices; and
in response to detection of rotation of the rotatable element, to select and display a second set of related images, wherein each of the first and second sets are selected from the plurality of sets of related images accessed from the online image store.
